(19) United States
(12) Patent Application Publication
(10) Pub. No.: US 2020/0041096 A1
(43) Pub. Date: Feb. 6, 2020

(54) LUMINAIRE WITH SPATIALLY SEPARATED SOLID STATE LIGHTING ELEMENTS

(71) Applicant: SIGNIFY HOLDING B.V., EINDHOVEN (NL)

(72) Inventors: SILVA MARIA BOOIJ, EINDHOVEN (NL); JOHANNES MARIA THIJSSEN, BEST (NL)

(21) Appl. No.: 16/339,095

(22) PCT Filed: Oct. 2, 2017
(86) PCT No.: PCT/EP2017/074979

§ 371 Date: Apr. 3, 2019

(30) Foreign Application Priority Data
Oct. 4, 2016 (EP) 16192122.6

(51) Int. Cl. F21V 5/00; F21S 8/04

(52) U.S. Cl. CPC F21V 5/004; F21Y 2105/16; F21S 8/04; F21V 5/007

(57) ABSTRACT

A luminaire (10) is disclosed comprising a plurality of spatially separated solid state lighting elements (13), each solid state lighting element associated with a lens element (17) arranged to shape a luminous distribution (21, 23) around an optical axis (14) of the solid state lighting element and at least one further optical element (19) arranged to redistribute at least part of a peripheral portion (23) of said shaped luminous distribution such as to reduce a perceived brightness of the solid state light element along a viewing angle coinciding with said peripheral portion.

### FIELD OF THE INVENTION

The present invention relates to a luminaire comprising a plurality of spatially separated solid state lighting elements, each solid state lighting element associated with a lens element arranged to shape a luminous distribution around an optical axis of the solid state lighting element.

### BACKGROUND OF THE INVENTION

Solid state lighting (SSL), e.g. LED lighting, is rapidly gaining popularity because of its energy credentials and superior lifetime compared to traditional lighting, e.g. incandescent lighting, fluorescent lighting and halogen lighting. Nevertheless, market penetration of such SSL devices is not without challenges. For example, a serious challenge is to provide a luminaire including SSL elements that offers the same visual experience as such traditional light sources. This is a far from trivial challenge, given that such luminaires typically comprise a plurality of spatially separated SSL elements that act as point sources, which may lead to pixelation and glare in the luminous output of the SSL-based luminaire. In particular, an observer of the luminaire under typical observation (viewing) angles, e.g. angles above 45°, may perceive the luminaire as displaying a plurality of bright spots that can be perceived as uncomfortable to look at, i.e. may cause glare, interspersed with darker areas, i.e. the spaces in between the SSL elements.

SSL elements are typically optically coupled with lens elements to shape the luminous distribution of the SSL elements in the far field, for example to achieve a desired illumination pattern at a typical distance from the luminaire, e.g. about 2-3 m from the luminaire in case of a ceiling-mounted luminaire such as a troffer, such that a comfortable and/or functionally suitable luminous distribution is achieved at the desired distance from the luminaire. Other examples for instance include the control of a beam angle and luminous distribution shape, e.g. spot size or shape, with such lens elements, and many more examples of the desired functionality of such lens elements are well-known to the skilled person.

However, due to their required functionality to shape far field characteristics of the luminous output of the SSL elements, such lens elements typically do not address the aforementioned issue of the perceived brightness (glare) of the SSL elements under certain viewing angles, or the perceived luminous inhomogeneity of the luminaire, i.e. the dark regions in between the spatially separated SSL elements, which contrast increases the brightness (glare) perception of the SSL elements, as for instance reported by L. M. Geerdinck et al., in Journal of Environmental Psychology 39 (2014), pages 5-13.

### SUMMARY OF THE INVENTION

The present invention seeks to provide a luminaire according to the opening paragraph in which at least some of the aforementioned problems have been addressed or at least reduced.

According to an aspect, there is provided a luminaire comprising a plurality of spatially separated solid state lighting elements mounted on a surface, each solid state lighting element associated with a lens element arranged to shape a luminous distribution around an optical axis of the solid state lighting element; and at least one further optical element extending essentially in a direction away from the surface and arranged to redistribute at least part of a peripheral portion of said shaped luminous distribution such as to reduce a perceived brightness of the solid state light element along a viewing angle coinciding with said peripheral portion, wherein each further optical element has at least one textured surface covered with micro-sized optical elements.

Mirco-sized in this context means dimensions in the range of 3 mm to 1 μm 1 n diameter, for example in a range of 1 mm to 10 μm or in a range of 0.5 mm to 50 μm.

In accordance with embodiments of the present invention, further optical elements are positioned relative to the SSL elements such that the peripheral portion of the luminous distribution created with the lens elements over the SSL elements gets further adjusted by the further optical elements, in order to reduce the perceived intensity of the peripheral portion of this luminous distribution when directly observed by an observer. The further optical elements may be considered to act as louver elements between the SSL elements although it should be understood that such louver elements in the context of the present application have a distinctively different function as louver elements used in prior art luminaires based on incandescent or fluorescent lighting, e.g. tube lighting, where the louver elements are included to block light exiting the luminaire under certain angles in order to shape the far field luminous distribution produced by such a luminaire and to prevent glare. In contrast, the further optical elements according to embodiments of the present invention do not seek to (completely) block (e.g. reflect) incident light, but rather seeks to at least redistribute this light in an adjusted forward direction, i.e. away from the SSL element generating it, in order to reduce the perceived brightness of the SSL elements under such viewing angles, i.e. to change the appearance of the SSL elements.

This for example may be achieved by each further optical element being arranged to increase the etendue of the peripheral portion of the shaped luminous distribution of an associated solid state lighting element, such that the solid state lighting element appears larger to the observer, thereby reducing the perceived brightness of the SSL element under these viewing angles and reducing the contrast between the SSL elements and in between spaces by redirecting the peripheral portions of the shaped luminous distributions of the respective solid state lighting elements such that some of this light appears to emanate from these in between spaces.

A textured surface structure may, for example, be formed by lenslets, prisms, facets, embossing patterns or etched/frosted patterning. The textured refractive surface is either fully transparent, diffusely translucent, or partly reflective in combination with partly transmissive. Said textured surface enables the further optical elements to achieve and finetune the desired redistribution of the peripheral portion of the shaped luminous distribution produced by the lens elements of the associated SSL elements.

The feature that each solid state lighting element is associated with at least one further optical element arranged to redistribute at least part of a peripheral portion of said shaped luminous distribution, can, for example, be attained by the number of further optical elements being at least equal to the number of solid state elements, i.e. in that a ratio R between the number of further optical elements and number of solid state elements is 1 or higher, for example R is 1.5, 2, 3.5, or 6.

In an embodiment, the peripheral portion comprises light emitted by the solid state lighting element under an angle of at least 450 with said optical axis, preferably under an angle of at least 550 with said optical axis, as these are typical viewing angles of many types of luminaires, in particular surface-mounted, e.g. ceiling-mounted luminaires such as troffers. Consequently, light emitted from the lens elements associated with the respective SSL elements under an angle of less than 45° or 55° may be directly directed into the far field, whereas light emitted by these lens element at larger angles is processed by the further optical elements to reduce the perceived brightness of the SSL elements as previously explained.

In order to obtain a particularly suitable redistribution of the light incident on the further optical elements, each further optical element may have at least one surface covered in semi-cylindrical lenslets extending in a direction away from the associated solid state lighting element, i.e. the further optical elements protrude, preferably essentially in a perpendicular direction away from the luminaire surface, such that light is effectively spread across a plane perpendicular to the optical axis of the SSL element.

The further optical elements may have any suitable optical property; for example, the further optical elements may be refractive, at least partially reflective or scattering. The further optical elements may be transparent, translucent, white or of a particular colour obtained via filtering/absorption of a part of the spectrum, for example to create colour effects in the periphery of the luminous distributions of the respective SSL elements, e.g. to increase the aesthetic appeal of the luminaire.

In some embodiments, different further optical elements have different optical properties as a function of their position within the luminaire. This for example may be used to create different luminous effects in the periphery of the luminaire compared to central regions of the luminaire, which may enhance the aesthetic appeal of the luminaire and/or meet certain functional requirements of the luminaire.

In an embodiment, the further optical elements are wedge-shaped, which has the advantage that the further optical elements may be manufactured in a straightforward manner. In particular, the further optical elements may be manufactured in a mold without creating an undercut, such that the further optical elements may be released from the mold in a straightforward manner.

Each further optical element may be arranged in between a pair of neighboring solid state lighting elements, wherein the respective further optical elements preferably are arranged in close vicinity, e.g. abutting, the associated SSL element to ensure the desired optical coupling between the SSL element and the further optical element.

In an embodiment where the luminaire has an elongated shape, the further optical elements are distributed in an elongation direction of said elongated shape and/or perpendicular to said elongation direction in order to shape the luminous output of the SSL elements as explained above.

However, in alternative embodiments, each further optical element may be mounted on one of said solid state lighting elements. For example, the further optical elements may have a rotationally symmetrical shape such as a cylindrical shape or a CPC shape and may be mounted around the lens elements.

In a particularly preferred embodiment, the luminaire further comprises a lens plate arranged over said solid state lighting elements, the lens plate comprising the lens elements and the further optical elements. Not only is this a cost-effective manner of providing the lens elements and the further optical elements, as they may be manufactured in a single process, it has the further advantage of ensuring that the further optical elements are correctly positioned relative to the lens elements to achieve the desired redistribution of the peripheral portions of the luminous distribution of the lens elements, which requires careful positioning of the further optical elements relative to the lens elements in case the further optical elements are discrete optical components that need to be positioned relative to the lens elements, e.g. attached to the lens elements using clips or the like or secured on a carrier or luminaire surface carrying the SSL elements over which the lens elements are mounted.

In an embodiment, the luminaire is for mounting relative to a surface such as a ceiling, and wherein the further optical elements are arranged to redirect a portion of the peripheral distribution towards said surface. This may improve the overall perception of an illuminated space such a room because the surface becomes more evenly illuminated, i.e. dark spaces in between the luminaires are reduced, which may also enhance a feeling of safety of the observers. The illumination of the surface may further act as guidance for people within a space in which the luminaire is mounted, e.g. as a route indication, for example because the orientation of the luminaire may become apparent from the surface illumination, from which the appropriate route may be deducted by said people. It furthermore assists in determining if the luminaire is switched on from a greater distance compared to luminaires in which the further optical elements are absent, which is beneficial to users having to decide which luminaires to switch on, e.g. in a space in which a plurality of luminaires are mounted, as such users may determine from a greater distance, e.g. from the controls of the luminaires, if the appropriate luminaires are already switched on. This may further utilized for commercial purposes, e.g. to indicate which areas are in use, e.g. in an open office space, storage facility, factory hall or in a restaurant or the like to indicate occupied tables or tables to receive a particular order for guidance purposes.

The luminaire according to embodiments of the present invention may have a planar luminaire surface onto which the SSL elements are mounted such that the SSL elements are arranged in a common plane although it should be understood that embodiments of the present invention are not limited to such an arrangement; other arrangements, for example arrangements in which the SSL elements are distributed across a curved luminaire surface or across a plurality of planar luminaire surfaces under non-zero angles with each other are equally feasible.

### BRIEF DESCRIPTION OF THE DRAWINGS

Embodiments of the invention are described in more detail and by way of non-limiting examples with reference to the accompanying drawings, wherein:

FIG. 1 schematically depicts a cross-sectional view of a luminaire according to an embodiment;

FIG. 2 schematically depicts an operational aspect of a luminaire according to an embodiment in a cross-sectional view;

FIG. 3 schematically depicts an operational aspect of a luminaire according to an embodiment in a top view;

FIG. 4 schematically depicts a luminance distribution of a prior art luminaire and a luminaire according to an embodiment;

FIG. 5 schematically depicts a cross-sectional view of a luminaire according to another embodiment;

FIG. 6 schematically depicts a cross-sectional view of a luminaire according to yet another embodiment;

FIG. 7 schematically depicts a bottom view of a luminaire according to a further embodiment;

FIG. 8 schematically depicts a bottom view of a luminaire according to a still further embodiment;

FIG. 9 schematically depicts a bottom view of a luminaire according to a still further embodiment;

FIG. 10 schematically depicts a perspective view of a luminaire according to an alternative embodiment; and

FIG. 11 schematically depicts an aspect of a luminaire according to yet another alternative embodiment in perspective view.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

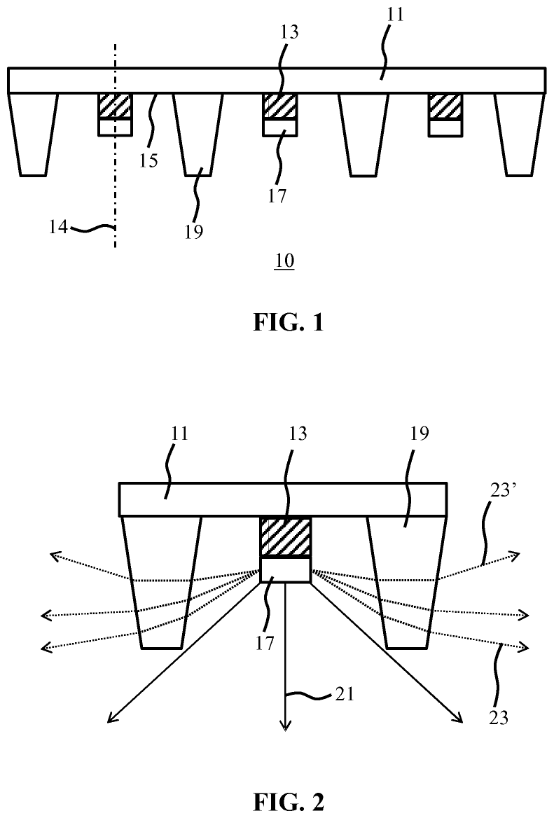

FIG. 1 schematically depicts a cross-sectional view of a luminaire 10 according to an embodiment of the present invention. The luminaire 10 comprises a carrier 11 such as a substrate functioning as a luminaire surface 11, a printed circuit board (PCB), or the like onto which a plurality of SSL elements 13 are mounted. Each SSL element 13 may be a single SSL element or a cluster of SSL elements that are grouped together such that during operation of the SSL element 13 the cluster gives the appearance of a single light source. The plurality of SSL elements 13 may be identical SSL elements such that the luminaire 10 emits light having the same spectral composition from each of the SSL elements 13 although in alternative embodiments the luminaire 10 may comprise different SSL elements 13, e.g. SSL elements configured to emit light of different spectral compositions, e.g. different colored light, white light of different colour temperatures, and so on. The luminaire 10 may further comprise a controller (not shown) for the SSL elements 13, which controller may be configured to operate the SSL elements 13 in unison or alternatively operate one or more SSL elements 13 individually, for example to switch on the SSL elements 13 in configurable regions of the luminaire 10. The SSL elements 13 may be dimmable in at least some embodiments. Any suitable type of SSL elements 13, e.g. any suitable type of LED, may be used in the luminaire 10. The luminaire 10 may further comprise additional components such as for example a motion detector, presence sensor or the like to automatically switch on the SSL elements 13 upon detection of a person within a space in which the luminaire 10 is mounted. The luminaire 10 may take any suitable form or shape, for example the luminaire 10 may be an indoor luminaire or an outdoor luminaire, and may be mountable in any suitable location. In some embodiments, the luminaire 10 may be mountable as a ceiling luminaire to illuminate the region of a space below the luminaire 10 such as an office space or corridor in the case of an indoor luminaire 10, or a walkway or the like in case of an outdoor luminaire 10. Other suitable use cases for such a luminaire 10 will be immediately apparent to the skilled person.

The SSL elements 13 of the luminaire 10 maybe spatially separated from each other such that neighboring SSL elements 13 are separated by a space 15 in between such neighboring SSL elements. The SSL elements 13 may be arranged in a regular pattern, e.g. a one-dimensional pattern such as a row or a two-dimensional pattern such as a grid in which the SSL elements 13 are spatially separated by respective spaces 15. Such a pattern in some embodiments may be a regular pattern. This causes the luminaire 10 to be perceived by an observer as a grid of bright light sources, i.e. the SSL elements 13, separated by dark regions, i.e. the spaces 15. This may be undesirable for a number of reasons. Firstly, due to the fact that the luminous flux of the luminaire 10 is produced by a relatively small number of concentrated point sources, i.e. the SSL elements 13, each point source is rather bright, such that direct observation of such a point source may be uncomfortable to the observer, i.e. may be perceived as glare. Secondly, many consumers consider the luminous output characteristics of traditional luminaires to be particularly aesthetically pleasing (because this is what they are used to) and are reluctant to replace such traditional luminaires with SSL-based luminaires if the latter produce a luminous distribution that clearly differs from that of such traditional luminaires; in other words, the perception of a row or a grid of bright point sources interspersed with darker regions may be considered aesthetically displeasing.

In order to manipulate the luminous output produced by the SSL elements 13, each SSL element 13 is typically associated with a lens element 17, as is well-known per se. Such a lens element 17 may be associated with the SSL element 13 in any suitable manner, for example may be mounted over the SSL element 13 or may form an integral part of the SSL element 13, e.g. may form part of a package such as a LED package to ensure that the lens element 17 is correctly positioned relative to the SSL element 13. Alternatively, the lens elements 17 may form part of a lens plate that may be mounted on the carrier 11 to ensure the correct spatial interrelation between each SSL element 13 and its corresponding lens element 17.

The lens elements 17 may transform the luminous distribution of the SSL elements 13 as transmitted around the respective optical axes 14 of the SSL elements 13, e.g. transform a Lambertian luminous distribution into a Gaussian luminous distribution. In this manner, the respective lens elements 17 shape the luminous distribution of the luminaire 10 in the far field. In the context of the present application, it should be understood that where reference is made to the far field, this is a reference to a target area to be illuminated by the luminaire 10. For instance, a luminaire 10 may be mounted at a typical distance or distance range from such a target area, e.g. around 2.3-2.7 m, in which case the lens elements 17 may be designed to create a particular luminous distribution at such a distance from the luminaire 10 by converting the luminous distribution produced by the SSL elements 13 in accordance with the desired particular luminous distribution.

It should be understood that the lens elements 17 may be of any suitable type and that embodiments of the present invention are not limited to a particular type of lens element 17. Moreover, the lens elements 17 may be made of any suitable material, e.g. glass or an optical grade polymer such as polycarbonate (PC), poly(methyl methacrylate) (PMMA), polyethylene terephthalate (PET) or the like, with such optical grade polymers having the further advantage that the lens elements 17 may be made using casting or moulding techniques, e.g. injection moulding or the like, which means that the lens elements 17 may be manufactured at low cost. In the context of the present application, a lens element may be any element capable of shaping a luminous distribution of the SSL element 13, i.e. an intensity distribution of the light generated by the SSL element 13, around its optical axis 14. For example, the lens element 17 may a refractive lens, a partially reflective lens, a total internal reflection lens, a collimator, and so on.

As previously explained, the lens elements 17 typically shape the luminous distribution of the corresponding SSL elements 13 in the far field but this does not necessarily address the aforementioned problems of glare perception and ‘spotty’ appearance of the luminaire 10 by an observer directly looking at the luminaire 10. In order to address this problem, the luminaire 10 further comprises at least one further optical element 19 and typically a plurality of such optical elements 19, arranged to redistribute at least part of a peripheral portion of the luminous distribution of the SSL elements 13 as shaped by the lens elements 17 such as to reduce a perceived brightness of the SSL element 13 along a viewing angle coinciding with said peripheral portion. In other words, each further optical element 19 is arranged to redistribute light exiting a lens element 17 under a certain minimum angle with the optical axis 14, which minimum angle may be 45°, 50° or even 55° such that light exiting an optical element 17 in a range of angles with the aforementioned angles as a lower end point of the range and for example 90° as the higher end point of this range is redistributed by a further optical element 19. Such range of angles corresponds to typical viewing angles of the luminaire 10 by an observer, such that an observer directly looking at the luminaire 10 under these angles does not directly look at a portion of the luminous distribution of an SSL element 13 but instead observes this portion of the luminous distribution as redistributed by a further optical element 19.

The further optical elements 19 may be compared to louvre elements as present in traditional ceiling-mounted luminaires such as troffers. However, it should be understood that the further optical elements 19 have a distinctly different function to such louvre elements, which were reflective elements that blocked part of the luminous distribution of a light source within such a troffer emitted from the troffer under certain angles. Such louvre elements consequently reduced the optical efficiency of such traditional luminaires due to the fact that such louvre elements absorbed part of the incident light, mainly because of such wedge-shaped louvres were spatially displaced relative to the light source such that a substantial fraction of the light produced by the light source was incident on the surface of the louvre facing the light source, causing partial absorption of this light. In contrast, in at least some embodiments, the further optical elements 19 redistribute the incident light by spreading it over a larger area such that the image of the SSL element 13 is increased in size, e.g. the etendue of the light incident on the further optical element 19 is increased, which has a two-fold effect; firstly, the peak brightness of this incident light is reduced, thereby reducing glare, and secondly by increasing the perceived size of the SSL elements 13, the dark spaces 15 in between the SSL elements 13 appear to become illuminated, thereby improving the homogeneity of the luminous output of the luminaire 10 and consequently improving its comfort and aesthetic appeal.

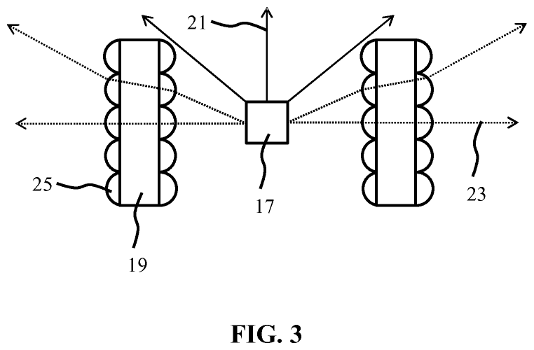

FIG. 2 schematically depicts a cross-sectional view of part of the luminaire 10 and FIG. 3 schematically depicts a top view of part of the luminaire 10 in which the optical principle of the further optical elements 19 is explained in further detail. Light emitted by an SSL element 13 of the luminaire 10 is shaped by its associated lens element 17 as previously explained to form a shaped luminous distribution that may be categorized as having a central portion 21 relative to the optical axis 14, i.e. around the optical axis 14, as indicated by the solid arrows emanating from the lens element 17. The central portion 21 may directly escape the luminaire 10 to form at least part of the far field luminous distribution produced with the luminaire 10 as explained in more detail above. The shaped luminous distribution further comprises a peripheral portion 23 as indicated by the dashed arrows emanating from the lens element 17, which peripheral portion 23 surrounds the central portion 21 and its incident on a further optical element 19, which further optical element 19 spreads the incident peripheral portion 23 in order to ‘smear’ the appearance of the peripheral portion 23 over a larger area (or volume), thereby reducing the perceived peak brightness of the SSL element 13 when observed under an angle coinciding with an angle within the angular distribution of the peripheral portion 23. For example, the further optical elements 19 may spread the peripheral portion 23 in a range of directions perpendicular to the plane of the carrier 11 to elongate the appearance of the SSL element 13 to an observer looking directly at the luminaire 10. This for example may be achieved by the inclusion of elongate lenslets 25 on the further optical elements 19 as will be explained in more detail below. In some embodiments, the further optical elements 19 may additionally spread the peripheral portion in the range of directions parallel to the plane of the carrier 11 to broaden the appearance of the SSL element 13, e.g. using appropriately shaped lenslets 25.

In an embodiment, the further optical elements 19 may be configured to redirect a portion 23′ of the peripheral portion 23 of the shaped luminous distribution toward the carrier 11, e.g. in an upward direction in case of a ceiling-mounted luminaire 10 such that a surrounding region of a mounting surface onto or into which the luminaire 10 is mounted is illuminated by the portion 23′, which reduces the contrast between the luminaire 10 and the mounting surface, which reduction in contrast may be perceived as aesthetically pleasing and may improve a feeling of safety.

Alternatively or additionally, each further optical element 19 may carry a plurality of lenslets 25, for example at least three, for example ten or forty, in the figure five on each surface, on at least some of its one or more surfaces that assist in reshaping the peripheral portion of the shaped luminous distribution incident on such a further optical element 19. In a particular embodiment, the lenslets 25 may be semi-cylindrical lenslets 25, which for example may extend in a direction away from the associated SSL element 13, e.g. in a direction away from the carrier 11 to protrude from the carrier or luminaire surface 11. However, it should be understood that the lenslets 25 may have any suitable shape and/or orientation; for example, in an alternative embodiment at least some of the surface(s) of the further optical elements 19 may be covered in prisms or the like to achieve the desired optical functionality of the further optical elements 19. The lenslets 25 may be positioned in any suitable manner (direction) on the further optical elements 19, e.g. on the entrance and/or exit surface of the further optical element 19.

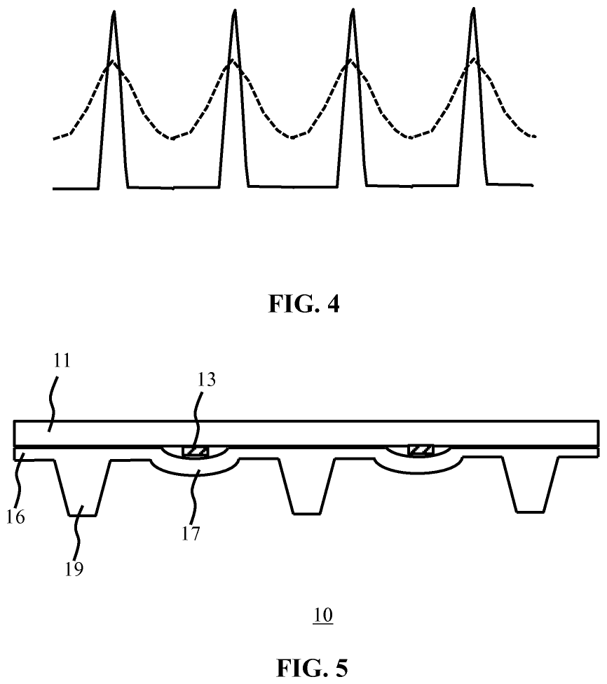

FIG. 4 schematically depicts the effect of the further optical elements 19 on the perceived luminance distribution produced with the luminaire 10 as observed under a viewing angle coinciding with an angle within the angular range of the peripheral portion 23 of the shaped luminous distribution of the luminaire 10. The solid line indicates the luminous distribution as observed in the absence of the further optical elements 19 and the dashed line indicates the luminous distribution as observed when the further optical elements 19 are included in the luminaire 10. In FIG. 4, the X-axis depicts carrier position and the Y-axis depicts luminance. As can be seen in FIG. 4, the inclusion of the further optical elements 19 reduces the peak intensity of the luminous distribution and spreads the luminous distribution in between the positions of the SSL elements 13, thereby creating an appearance of illuminating the spaces 15 in between the SSL elements 13 when observed under the aforementioned viewing angles. As previously explained, this perceived spreading of the peripheral portion of the shaped luminous distribution may be achieved by texturing or structuring the further optical elements 19, e.g. by the inclusion of lenslets 25 on at least some of the surface(s) of the further optical elements 19.

As shown in FIGS. 2 and 3, the further optical elements 19 are refractive optical elements to achieve the desired redistribution of the peripheral portion 23 of the shaped luminous distribution produced by the lens elements 17 of the associated SSL elements 13. However, it should be understood that this is by way of non-limiting example only. It is equally feasible that the further optical elements 19 are reflective or scattering, e.g. volume scattering or surface scattering optical elements. The further optical elements 19 may be transparent or alternatively may be coloured, e.g. white or a different colour in case it is desirable to create the colour effect with the luminaire 10. The further optical elements 19 may be transmissive or partially reflective or partially absorbing, e.g. translucent. The further optical elements 19 of the luminaire 10 may be identical or alternatively may be different to each other. Specifically, the optical characteristics of a particular further optical element 19 may be governed by the location of the further optical elements 19 within the luminaire 10 such that further optical elements 19 in different locations have different optical properties. In this manner, the luminaire 10 for example may be given a different appearance depending on a distance from the luminaire 10, which may increase the aesthetic appeal of the luminaire 10. Alternatively, different regions of the luminaire 10 may be given a different appearance in this manner, e.g. a different central and edge region, to enhance the aesthetic appeal of the luminaire 10.

The further optical elements 19 may be made of any suitable material and in any suitable shape. For example, the further optical elements 19 may be made of glass or a suitable optical grade polymer such as PC, PMMA or PET or the like, the latter materials having the advantage that the further optical elements 19 may be made in a low-cost manner, e.g. using casting or moulding techniques such as injection moulding. In order to ensure easy release of the further optical elements 19 from the mould, the further optical elements 19 may be wedge-shaped, thereby avoiding the presence of an undercut in the mould preventing release of the further optical element 19 from the mould. The further optical elements 19 may be discrete elements, which may be individually mounted in the luminaire 10, e.g. on the carrier 11 in any suitable manner. However, as will be readily understood by the skilled person, in order for the further optical elements 19 to perform the desired optical function, the further optical elements 19 must be correctly positioned relative to the lens elements 17 and preferably located in close vicinity to the SSL elements 13. For example, the further optical elements 19 may be clipped or otherwise attached to an associated lens element 17 in order to facilitate establishment of the correct optical interrelation between the lens elements 17 and the further optical element 19.

FIG. 5 schematically depicts a particularly advantageous embodiment of the present invention, in which the lens elements 17 and the further optical elements 19 both form part of a single lens plate 16, which may be positioned on the carrier 11 such that each lens element 17 is correctly aligned with a corresponding SSL element 13 as is well-known per se. The advantage of the provision of such a single lens plate 16 (or a plurality of lens plate segments that combine to form a single lens plate 16) is that each lens element 17 is correctly positioned relative to an associated further optical element 19. In addition, in such an embodiment, the lens elements 17 and the further optical elements 19 may be manufactured in a single manufacturing step, e.g. a moulding step, in which case the lens element 17 and the further optical elements 19 may be made of the same material, e.g. an optical grade polymer material as explained above, which means that the lens elements 17 and the further optical elements 19 may be provided in a particularly cost-effective manner.

Alternative embodiments of the lens elements 17 and further optical elements 19 may include combined optical elements including the lens element 17 and further optical element 19 in a single optical element, in which each SSL element 13 may be associated with a separate one of such combined optical elements. Other alternatives will be apparent to the skilled person.

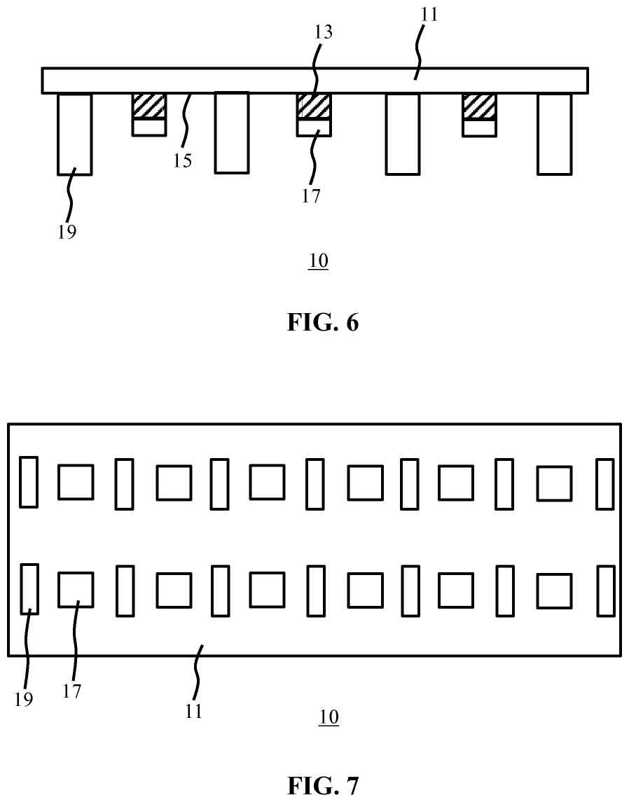

At this point, it is noted that the further optical elements 19 are not necessarily wedge-shaped but may have any suitable shape. For example, as schematically depicted in FIG. 6, the further optical elements 19 may be plate-shaped and positioned in between neighboring SSL elements 13.

The luminaire 10 in accordance with embodiments of the present invention may have any suitable shape, such as an elongate shape, e.g. a linear luminaire, a rectangular luminaire or the like although other shapes, e.g. circular shapes, angular shapes, ellipsoid shapes, and so on are equally feasible. In case of an elongate luminaire 10, the further optical elements 19 may be positioned in between the SSL elements 13 and their associated lens elements 17 in the elongation direction of the luminaire 10 as schematically depicted in FIG. 7. This for example may be a suitable embodiment when the luminaire 10 is mounted over an elongate walkway or corridor with the elongation direction of the luminaire 10 coinciding with the elongation direction of the walkway or corridor, such that people walking along such a walkway or corridor and looking directly at the luminaire 10 will perceive the dashed luminance distribution of FIG. 4 created by the further optical elements 19 redistributing the peripheral part 23 of the shaped luminous distribution created by the lens elements 17 as explained above.

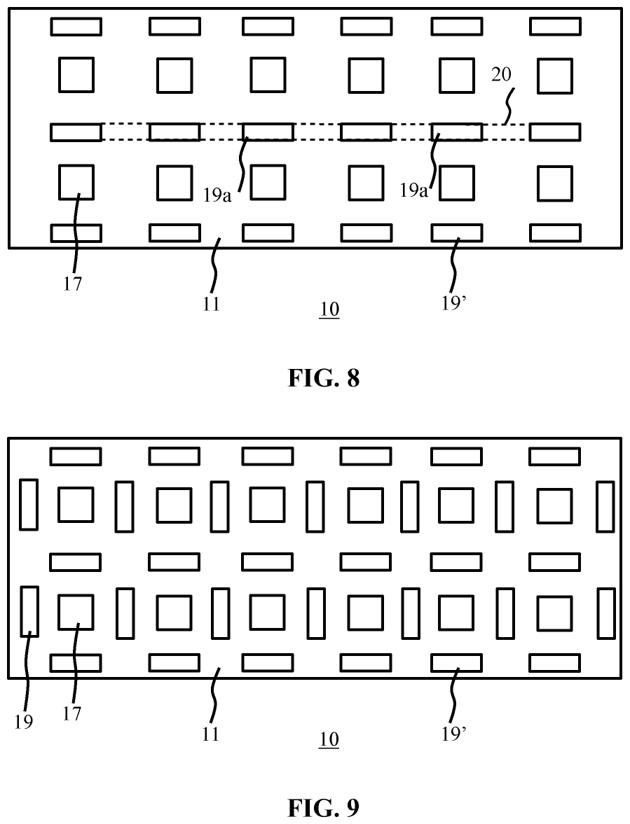

Of course, where the luminaire 10 in such a use case is mounted such that its elongation direction is perpendicular to the elongation direction of the walkway or corridor, the further optical elements 19 may be positioned in between neighboring SSL elements 13 perpendicular to the elongation direction of the luminaire 10 as schematically depicted in FIG. 8, in order to achieve the same perception of the luminaire 10 by an observer walking along the walkway or corridor and directly observing the luminaire 10 as explained above. Though the further optical elements arranged in a row 20 in the elongation direction are shown as separate elements 19a, said separate elements in one row could well be embodied as one integral part in said elongation direction (indicated by the dashed line), in which the further optical elements might be considered as being virtually separated (only shown for one row in FIG. 8, but this could be the case for each row). Moreover, as schematically depicted in FIG. 9, it is equally feasible that the luminaire 10 comprises further optical elements 19 in between neighboring SSL elements 13 both in the elongation direction and perpendicular to the elongation direction of the luminaire 10, which for instance may be advantageous in case observers may approach the luminaire 10 from different directions.

At this point, it is noted that if the further optical elements 19 at least partially surround the SSL elements 13, at least some light produced by the SSL elements 13 will be visible from the side of the luminaire 10. The further optical elements 19 may be shaped such that a substantial portion of light incident on the further optical elements 19 is redirected towards the side of the luminaire 10 to improve visibility of the side of the luminaire 10, e.g. from a distance. This for example may be utilized in a use case where one or more luminaires 10 are mounted in an elongation direction of a corridor, walkway, path or the like in order to guide a person trying to find his or her way in the intended direction. Moreover, such luminaires 10 with sideways directed luminance may be more clearly identifiable from a distance, such that a person can tell from the distance whether or not the luminaire 10 is switched on. This for example may assist this person in deciding which further luminaires, e.g. further luminaires 10, should be switched on in order to achieve a desired illumination of a space in which the luminaires are mounted.

In the above embodiments, the further optical elements 19 partially surround associated SSL elements 13. Consequently, if an observer looks at the luminaire 10 under an angle within the angular range of the peripheral portion 23 of the luminous distribution of the SSL element 13 as shaped by its associated lens element 17 which bypasses the further optical elements 19, this luminous portion is not reshaped and perceived by the observer as the luminance distribution as indicated by the solid line in FIG. 4. This for example may occur in use cases in which the luminaire 10 may be approached or observed from any direction, e.g. if the luminaire 10 is mounted in a large space such as an open plan office space or the like. In such a scenario, each further optical element 19 may completely surround an associated SSL element 13 in order to achieve the desired reshaping of the peripheral portion 23 of the luminous output of the SSL element 13 as shaped by the lens element 17 from any observation direction. To this end, each further optical element 19 may be rotationally symmetrical, e.g. having a circular circumference or a rotationally symmetrical circumference, such as a hexagonal shape, and may be mounted such that its axis of symmetry coincides with the optical axis 14 of an associated SSL element 13.

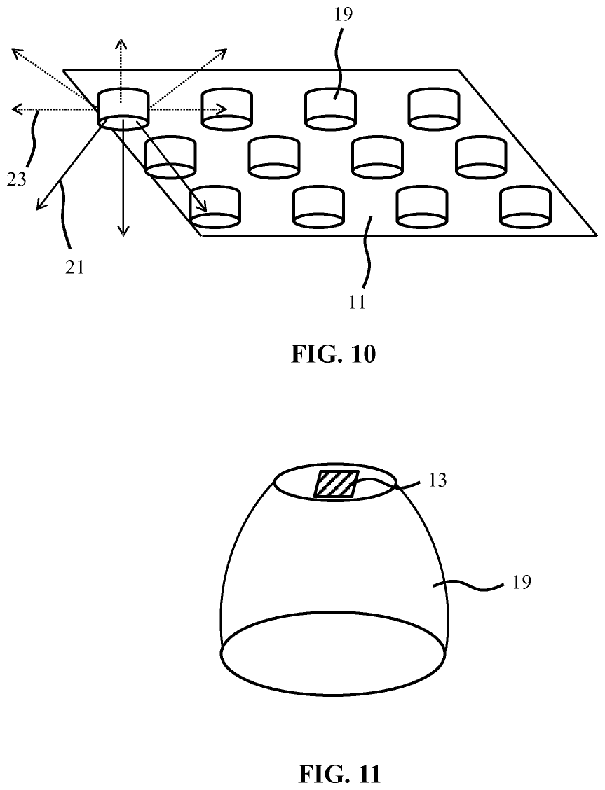

An example embodiment of such a luminaire 10 is schematically depicted in FIG. 10, in which each SSL element 13 is surrounded by a cylindrical further optical element 19. As indicated by the arrows in FIG. 10, this ensures that the luminaire 10 gives substantially the same appearance when viewed under a particular viewing angle irrespective of the position of the observer observing the luminaire 10 under such a viewing angle. It is furthermore noted that such cylindrical further optical elements 19 are particularly suitable to create the aforementioned uplighting effect in which part 23′ of the peripheral portion 23 of the shaped luminous distribution incident on the further optical element is redirected to part of the mounting surface onto or into which the luminaire 10 is mounted.

FIG. 11 schematically depicts another example embodiment of a rotationally symmetric further optical element 19, here having an (approximated) compound parabolic concentrator (CPC) shape for reshaping part of the luminous distribution of the SSL element 13 as previously explained. Other rotationally symmetrical shapes of the further optical elements 19 are of course equally feasible. Such rotationally symmetrical further optical elements 19 may be mounted around the SSL elements 13 or on the SSL elements 13.

Finally, it is noted that although in the above embodiments the SSL elements 13 are mounted in a common plane of the luminaire 10, e.g. on a planar common carrier functioning as luminaire surface 11, it should be understood that embodiments of the luminaire 10 are not limited to such a planar arrangement. For example, it is equally feasible that the SSL elements 13 are mounted on a curved (convex concave) luminaire surface or distributed across a plurality of planes under non-zero angles with each other, e.g. a U-shaped or V-shaped mounting surface arrangement.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A luminaire comprising a plurality of spatially separated solid state lighting elements mounted on a surface, each solid state lighting element associated with:
a lens element arranged to shape a luminous distribution around an optical axis of the solid state lighting element;
and at least one further optical element extending essentially in a direction away from the surface and arranged to redistribute at least part of a peripheral portion of said shaped luminous distribution such as to reduce a perceived brightness of the solid state light element along a viewing angle coinciding with said peripheral portion,
wherein each further optical element has at least one textured surface covered with micro-sized optical elements
wherein the peripheral portion comprises light emitted by the solid state lighting element under an angle of 45° to 55° with said optical axis.

2. The luminaire of claim 1, wherein each further optical element is arranged to increase the etendue of the peripheral portion of the shaped luminous distribution of an associated solid state lighting element.

3. (canceled)

4. The luminaire of claim 1, wherein each further optical element has at least one surface covered in lenslets, optionally wherein the lenslets are semi-cylindrical lenslets.

5. The luminaire of claim 1, wherein the further optical elements are wedge-shaped.

6. The luminaire of claim 1, wherein the further optical elements are refractive, and optionally additionally at least partially reflective or scattering.

7. The luminaire of claim 1, wherein different further optical elements have different optical properties as a function of their position within the luminaire.

8. The luminaire of claim 1, wherein each further optical element is arranged in between a pair of neighboring solid state lighting elements.

9. The luminaire of claim 8, wherein the luminaire has an elongated shape, and wherein the further optical elements are distributed in an elongation direction of said elongated shape and/or perpendicular to said elongation direction.

10. The luminaire of claim 1, wherein the further optical elements have a rotational, preferably a rotationally symmetrical, shape and are mounted around the lens elements.

11. The luminaire of claim 10, wherein the further optical elements have a cylindrical shape or a CPC shape and are mounted around the lens elements.

12. The luminaire of claim 10, wherein each further optical element is mounted on one of said solid state lighting elements.

13. The luminaire of claim 1, further comprising a lens plate arranged over said solid state lighting elements, the lens plate comprising the lens elements and the further optical elements.

14. The luminaire of claim 1, wherein the luminaire is for mounting relative to a surface, and wherein the further optical elements are arranged to redirect a portion of the peripheral distribution towards said surface.

15. The luminaire of claim 1, wherein the solid state lighting elements are arranged in a common plane.
